(19) United States
(12) Patent Application Publication
(10) Pub. No.: US 2002/0080472 A1
(43) Pub. Date: Jun. 27, 2002

(54) Multiport optical amplifier and method of amplifying optical signals

(76) Inventors: Tom Haslett, Toronto (CA); Steve Hill, Toronto (CA); Blaine Hobson, King City (CA); David Demmer, Toronto (CA); Mike Liwak, Pickering (CA); Nikolay Stoev, East York (CA)

Correspondence Address: Daniel A. Scola, Jr., HOFFMANN & BARON, LLP, 6900 Jericho Turnpike, Syosset, NY, 11791, US

(21) Appl. No.: 09/988,876

(22) Filed: Nov. 21, 2001

(30) Foreign Application Priority Data
Nov. 22, 2000 (CA) 2,327,045
Sep. 26, 2001 (CA) 2,357,809

(51) Int. Cl. H01S 3/00

(52) U.S. Cl. 359/341.3

(57) ABSTRACT

An amplifier for optical signals is disclosed. The amplifier includes a source of optical pump power and a containment body for substantially containing the pump power at a predetermined power intensity. At least one guided signal path passes through the containment body, the signal path being capable of carrying at least one optical signal component. The source of optical pump power is coupled to the containment body. In one embodiment the containment body is a transparent material surrounded by a material having a lower index of a fraction. Pump power is contained within the containment body by means of total internal reflection (TIR). In another embodiment the containment body is formed from a metallic reflective material which surrounds the guided signal paths passing through the containment body.

### FIELD OF THE INVENTION

This invention relates to the general field of optical communications and more particularly to the processing and control of optical signals. Most particularly, this invention relates to the amplification of optical signals in an optical amplifier.

### BACKGROUND OF THE INVENTION

Long distance and local telecommunication systems increasingly rely on fibre optic networks to carry digital information. The advent of Dense Wavelength Division Multiplexing (DWDM), which enables a large number of wavelengths or channels to be packed into a single fibre, has increased data capacity enormously and spurred further interest in this technology.

To function efficiently over long distances, optical networks require periodic re-amplification of the signal to compensate for transmission losses. Further, re-amplification may also be needed at switching points where the signal is distributed from the long distance to the various intermediate and local parts of the network. Typically, amplification has been accomplished by converting the optical signal into electrical form, performing amplification and other signal processing functions using known electronic techniques, and then if necessary, converting the electrical signal back to an optical signal for continued transmission. However, this approach involving constant signal conversions is costly, complicated, and inefficient. Accordingly, there is an interest in the development of optical components that can amplify and further process the optical signal directly. This should be beneficial in reducing the number of optical - electrical - optical (OEO) conversions required in the network.

An optical amplifier of recent application is the erbium doped fibre amplifier (EDFA). This comprises a section of fibre optic cable of predetermined length that is inserted in series with the transmitted signal. The EDFA fibre optic waveguide is doped with a photoreactive material, most commonly the rare earth element erbium. For the EDFA to operate; a second, “pump” laser beam must be applied through the doped fibre optic waveguide. This pump laser or pump beam operates at a frequency and intensity calculated to stimulate the photoreactive dopant, and is most commonly at frequencies corresponding to a wavelength of 980 nanometers and/or 1480 nanometers. The pump beam co-propagates with the transmitted signal through the EDFA and may need to be removed from the signal at the output, upon re-connection of the transmitted signal with the main line. The purpose of the pump laser is to achieve a population inversion of electrons of the rare earth dopant elements to higher energy levels. Under stimulation, the excited electrons decay and photons are produced. The generated photons propagate coherently with the original transmitted signal, so that the output signal is larger or amplified compared to the input.

Due to the long interaction length between the pump beam and the doped material, the energy utilization of the pump beam is quite high. However, there are a number of problems with the EDFA approach that adversely affect its performance and cost.

One issue is that the pump laser used in an EDFA typically needs to have an accurate and stable wavelength with as much power as possible in a fundamental mode. This leads to more expensive and complex lasers suitable for coupling to a fibre. This has led to the necessity of using lasers having expensive control mechanisms. Further, since the pump laser's emitted signal tends to attenuate sharply with distance, it is common for EDFAs to require several pump lasers, inserted at intermediate points along the pumped beam path. The pump energy needs to be coupled into the fibre or waveguide carrying the signal, which requires accurate alignment and a method to ensure that the coupling is stable over time, both requirements adding complexity and expense. Also there is a difficulty in multiplexing the pump energy to the signal to be amplified which again adds expense and complexity to the design.

In practice, attaining the desired optical amplifier gain commonly translates into physical fibre lengths on the order of 5- 100 meters. For this reason EDFA fibres are routinely coiled to save space, but still are rather bulky. Since one EDFA can only handle a single fibre optic cable, a typical network installation may easily require quite a large number of EDFAs. The physical bulk of individual EDFAs therefore imposes a need for considerable space wherever such equipment is installed, which in turn raises the overall cost of running an optical network. It also has the effect of restricting any proposed all-optical interconnection points to the larger, long-haul switching points on the network, as the cost and size of EDFAs make it difficult to economically implement an all-optical solution at smaller local nodes and or subnets, such as for use in metro networks.

### SUMMARY OF THE INVENTION

What is required is an optical amplifier which overcomes the limitations associated with EDFAs and the other known amplifying arrangements. Specifically a pumping arrangement which permits the use of a simple and inexpensive pump source is desirable. Further an arrangement which eliminates the coupling losses of coupling the pump source to the fibre is also desirable.

To enable the amplifier to be widely implemented, it would be advantageous if it were composed of relatively inexpensive materials and be simple and inexpensive to manufacture. Preferably, the device would be small in size, and able to simultaneously amplify multiple independent optical signals. In this way the device could be cost effective, and thereby help bring about all-optical communication networks, including communications in metro networks.

According to the first aspect of the present invention, there is provided an amplifier for optical signals, said amplifier comprising:

a source of optical pump power;

a containment body for substantially containing said pump power at a predetermined power intensity;

at least one guided signal path passing through said containment body, said signal path being capable of carrying at least one optical signal component; and

a means for coupling said source of power to said containment body.

According to a further aspect of the present invention there is provided an amplifier for amplifying optical signals, said amplifier comprising:

a reflective containment body;

a source of pump light directed into said containment body;

at least one doped guided signal path passing through said containment body, and

a means for coupling said source of pump light to said containment body, wherein said pump light is directed generally transverse to said at least one guided signal path and is reflected back through said signal paths by said reflective surface.

According to a further aspect of the present invention there is provided a method of amplifying an optical signal comprising the steps of:

providing a containment body to contain an optical pump energy, said containment body having at least one guided signal path passing therethrough;

pumping said containment body with enough optical pump energy to permit said containment body to achieve a predetermined energy intensity level;

stimulating a guided signal path with said energy intensity; and

amplifying an optical signal passing through said guided signal path.

According to a further aspect of the present invention there is provided an amplifier for amplifying optical signals, said amplifier comprising:

an amplifier body;

at least two doped guided signal paths passing through said body;

at least one source of pump energy directed at said body;

wherein said pump energy impinges on both of said at least two doped guided signal paths.

### BRIEF DESCRIPTION OF THE DRAWINGS

Reference will now be made, by way of example only, to various drawings which depict preferred embodiments of the invention and in which:

FIG. 1 is a side view of a first embodiment of a multiport amplifier according to the present invention having a containment body which includes a containment chamber having reflective surfaces;

FIG. 2 is a top view of the embodiment of FIG. 1 along lines 2-2;

FIG. 3 is a further side view of the containment body of FIG. 1 showing a different form of pump source;

FIG. 4 is a graph illustrating a relationship between the optical pump intensity in the containment chamber and the reflectivity of the chamber walls;

FIG. 5 is graph illustrating the relationship between the optical pump intensity in the containment chamber and the number of signal paths traversing the chamber;

FIG. 6 is a graph showing the relationship between the pump intensity in the chamber and the slit width d and a cavity width w;

FIG. 7 is a drawing of a further embodiment of the present invention showing an alternate form of containment body which includes total internal reflection surfaces; and

FIG. 8 is a drawing of a further embodiment showing a side pumping arrangement which reuses the optical pump energy.

### DETAILED DESCRIPTION OF THE PREFERRED EMBODIMENTS

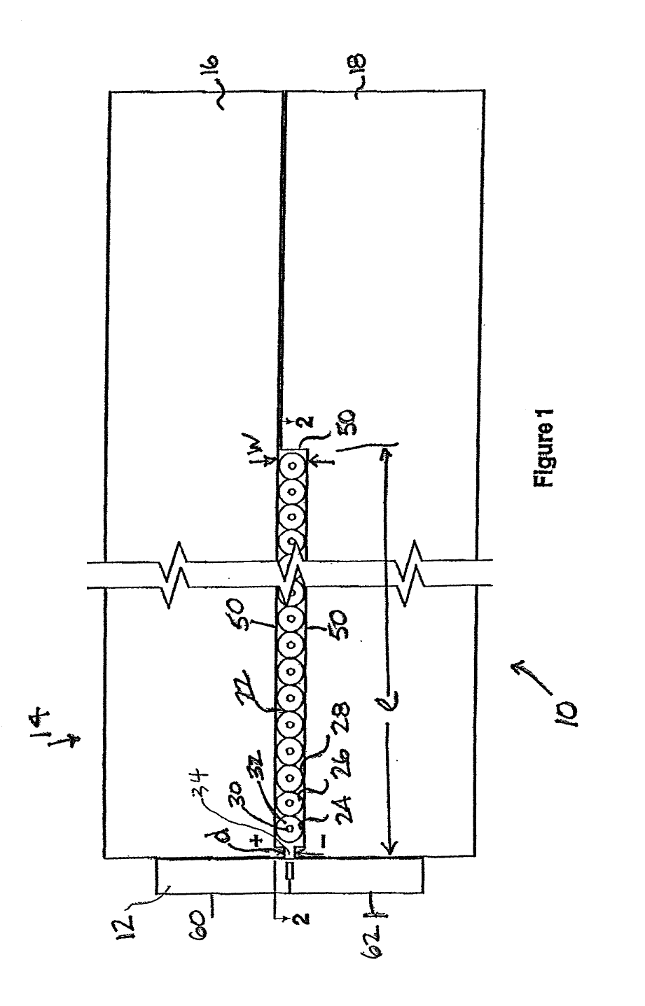

A first embodiment of a multiport amplifier for optical signals according to the present invention is generally shown as 10 in FIG. 1. The multiport amplifier 10 has a source of optical pump power 12 associated with a containment body 14 which for example, may be made up of an upper containment element 16 and a lower containment element 18. The containment body is for substantially containing the optical pump energy emitted from the optical pump source 12 at a predetermined power intensity.

It will be understood by those skilled in the art that for optical amplifiers where the signal and the pump light are co-propagating, such as in erbium doped fibre amplifiers (EDFAs) the efficiency of utilization of the pump energy is high. Utilization is high because of the long interaction length between the attached pump light energy and the doped signal path. As shown in FIG. 1, the present invention comprehends a side pump configuration, meaning that the pump beam is not co-propagating with the signal. In the preferred embodiment the pump signal is generally transverse to the signal to be amplified, but the present invention comprehends a full s orange of angles other than co-propagating. For a side pumping arrangement as in the present invention, the amount of energy absorbed in any given pass is small. Thus, the present invention is directed to an invention which reuses pump energy not initially absorbed.

The containment body 14 defines a containment chamber 22 for this purpose. Passing through the containment chamber 22 are a number of guided signal paths the first three of which are shown as 24, 26 and 28. Although three signal paths are numbered, the present invention comprehends that more or fewer could be used, as explained in more detail below. In a preferred form of the invention, each of the signal paths 24, 26 and 28 is comprised of a guided signal path having a core 30 and a cladding 32. At least a portion of the signal path needs to be doped with a photo reactant dopant so the pump energy can be absorbed by the dopant and passed to the optical signal to be amplified. The doping strategies employed in the present invention are described in more detail below.

The containment chamber 22 has a height w which is most preferably approximately the same size as the cladding 32. The containment chamber 22 also includes an input slit 34 having a height d. In a preferred embodiment of the invention, the chamber 22 is formed with reflective surfaces 50. Optical energy entering the chamber through the slit 34 will therefore be reflected off the reflective surfaces 50 and be thus contained within the containment chamber 22. Gold coated surfaces are suitable reflective surfaces. Through the use of reflective surfaces, a power intensity can be built up within the chamber 22 which intensity can be then used to transfer optical energy for the purpose of amplifying optical signals passing through the guided signal paths in the chamber 22.

The present invention comprehends all different types of chamber shapes, with the only limitation being that even with a highly reflective surface some energy is lost on reflection. Therefore, the more reflections occurring, the lower the power of the pump beam. Therefore, a configuration which minimizes the number of reflections occurring per interaction between the pump light and the energy-absorbing portion of the signal path is desirable. Reasonable results have been achieved by making the amplifier chamber generally rectangular in cross-section, where the dimension w of the chamber 22 roughly corresponds to the diameter of the guided signal path. In this sense, the diameter of the guided signal path is defined as the outer cladding surface diameter of the waveguide. The present invention therefore comprehends various sizes and shapes of containment chamber 22 provided that the basic attributes of containment of the pump energy to create a sufficient energy intensity are met.

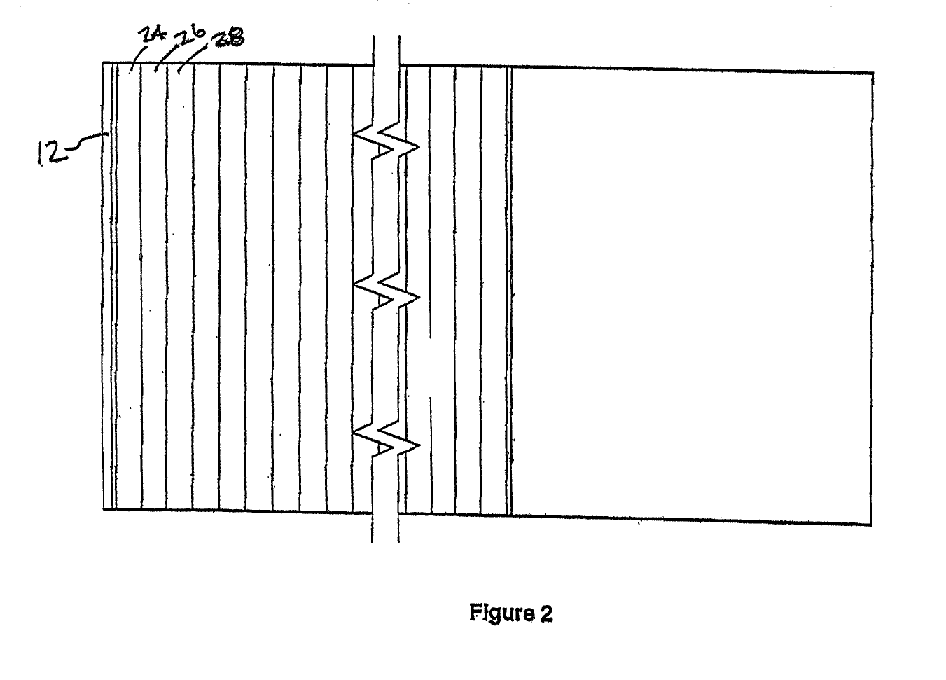

FIG. 2 shows a top view of the invention of FIG. 1. The pump source 12 extends along the body, and may for example be a bar laser. The signal paths 24, 26 and 28 are generally parallel and pass through the containment chamber. Because of the reflective surfaces, the pump energy is contained in the chamber at a certain power intensity level. The degree of amplification of any given optical signal is therefore a function of the amplification per unit length of pumped signal path times the pumped path length. As will be understood by those skilled in the art, the degree of amplification can be varied by varying one or more of a number of factors, such as pump energy intensity, dopant concentration and pumped path length. Amplification, for peak gains in the range of between 70 db and 20 db are available by the present invention.

The side pump configuration of the present invention permits the use of, for example, inexpensive bar lasers, which require no coupling of the pump light energy into a fibre. All that is required is to pass the pump energy into the chamber 22 through the slit 34. However, side pumping has. a draw back in that the pump light energy only interacts across a width of the signal path and therefore passes through a signal path with very little absorption on a single pass. The present invention addresses the efficiency issue and provides a sufficient transfer of energy from the pump light to the optical signal to amplify the latter through a number of strategies, including doping and energy containment. Further as can now be appreciated according to the present invention, a plurality of guided signal paths can be pumped by the same optical pump source, meaning the cost of amplification per signal can be reduced.

Turning to FIG. 1, electrical connections 60 and 62 are shown for the optical power source 12. One preferred form of optical power source is a simple bar laser. Ideally, the bar laser will be placed adjacent to the slit 34 for the purpose of permitting the optical energy from the bar laser to be passed through the slit 34 and collected in the chamber. As will be understood by those skilled in the art, if the laser is touching the body 14 of the amplifier, and the amplifier is made from a conductive material such as metal, then the electrical connections 60 and 62 will need to be electrically insulated from the body to avoid shorting out Coupling the pump energy to the chamber 26 requires lining up the pump source with the slit 34.

According the present invention, the doping of the signal paths is one of the parameters which affects the degree of amplification of the optical signals passing through the multiport amplifier 10. As will be understood by those skilled in the art, an optical amplifier typically is comprised of a dopant, located in a medium, where the dopant is capable of absorbing pump energy, often at one range of frequencies or wavelengths, and amplifying optical signals of different frequencies and wavelengths. Amplification occurs because the pump energy causes the dopant to achieve an excited electronic state (inversion) which is the condition necessary for optical signal amplification. As electron pairs decay, under the stimulation of an optical signal, optical energy is produced which is coherent with and thus amplifies the optical signal impinging on the excited dopant.

The preferred dopant for the core according to the present invention is erbium. The erbium may be directly optically pumped, namely it may absorb pump energy directly, or, it may be used in association with the sensitizer such as ytterbium. Ytterbium as a sensitizer absorbs pump light more efficiently and can be used to pass the absorbed optical energy to the erbium. Thus, the present invention comprehends having the cladding doped with ytterbium and the core doped with erbium. Provided sufficient optical energy is absorbed by the erbium, the erbium will reach on average an excited electron state (inverted) which is the condition for optical amplification. The most preferred ranges are 3 to 5% by weight Erbium and 18 to 22% by weight Ytterbium. Other sensitizers can also be added such as chromium without departing from the present invention such as will be known by those skilled in the art.

In general terms, the more pump energy present, the more energy will be absorbed and the higher the inversion leading to higher gain during amplification. Of course , this trend reaches a maximum when the dopant, such as erbium, is entirely inverted. The maximum gain achieved is a direct function of the concentration of erbium in the amplification path of the optical signal. As will be understood by those skilled in the art, an increase in erbium concentration, also increases erbium to erbium interactions, in a nonlinear manner such that the pump energy required to reach maximum gain rises also non-linearly. Such a non-linear rise in the requirement for the pump energy places a practical limit on the concentration of erbium that can be used. In general, the higher the pump energy available per unit length, the higher the concentration of erbium that can be used and consequently the higher gain per unit length of amplifier path.

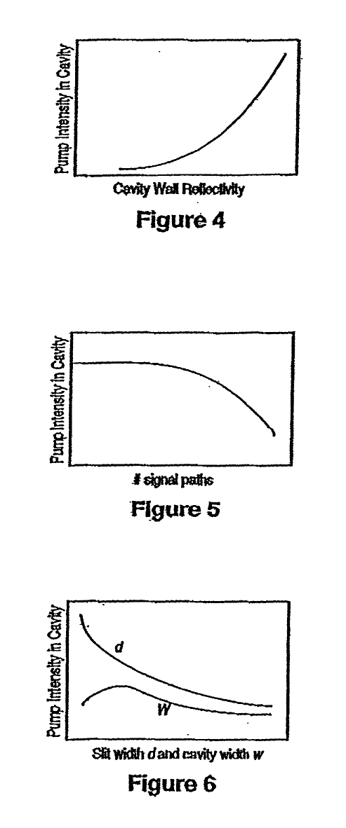

Pump energy injected into the chamber is lost over time. The losses arise through a number of separate mechanisms. The first, is absorption of the pump energy at the reflective chamber walls. FIG. 4 shows a general trend of this characteristic. As will be now appreciated, the present invention comprehends the pump light will endure many reflections on average before it is absorbed by one of the doped signal paths. FIG. 4 shows the drop in chamber 22 pump intensity is rapid with decreasing reflectivity from the chamber wall. Thus, according to the present invention, maximum reflectivity of the chamber wall is desired to limit this undesirable loss of energy and to maintain an energy intensity within the chamber at an optimal high level.

The second way that energy is lost in the cavity is by absorption in the amplification path. As can now be understood, if there are only a few fibres in the cavity, the absorption loss represents a small loss as compared to the absorption loss through the cavity reflective walls. However, as more signal paths are added to the cavity, the absorption in the multiple amplification paths will begin to affect the pump energy intensity in the chamber 22. This is illustrated in FIG. 5.

FIG. 6 depicts the change in power intensity caused by narrowing the width of an entrance slit d or varying the width of the chamber w. The smaller the slit width d, the greater the pump intensity in the chamber; essentially, the smaller the slit width d the lower the losses are out of the slit 34. Thus, a small slit is desirable. A limit on the physical size of the slit is the need to couple the pump laser source through the slit. In other words, a slit so small as to prevent a substantial portion of the laser source from being coupled to the chamber 22 would be counterproductive. Thus, losses through the slit 34 are another factor which limits the maximum power density in the containment chamber 22.

It will also be noted that the effect of the height of the chamber affects the pump intensity in a more complex way. At higher values of w the pump intensity gradually declines. Further, at low values of w, the pump intensity increases rather rapidly, to a peak, and then starts to decline, or stated in other terms, as w is made smaller, fewer reflections occur meaning the pump energy intensity rises. As this figure shows though, a decrease in w is accompanied by an increase in the relative amount of pump energy lost out through the slit 34. As a result there is a reduction in the benefit of reducing w to this extent. The present invention comprehends an optimum value for a given size w and slit size d. Also, the length of the chamber l should be minimized to the number of signal paths present.

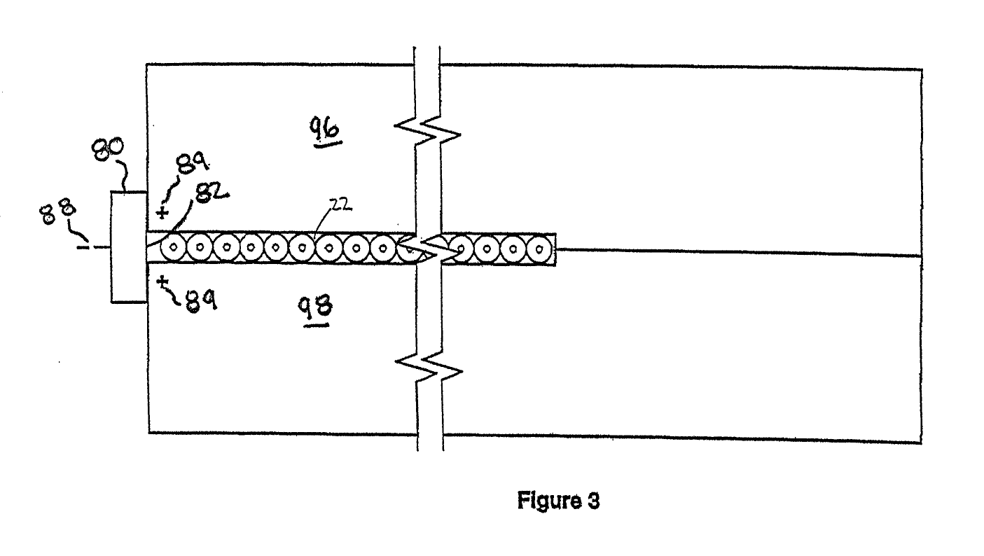

The present invention comprehends configuring the optical pump energy source and the slit 34 so that such losses are as small as possible. In the embodiment of FIG. 3 the pump source 80 is a surface emitting laser, which has small circular emitting regions and non-emitting lands located between the circular emitting regions on a surface 82. This type of laser is shown in U.S. Pat. No. 6,243,407. According to the present invention the surface 82 can be made reflective with a gold coating or the like. In this manner the surface emitting laser can be used to form one end of the containment chamber 22. While there will still be losses, and thus there will be an nominal slit size for energy loss calculations, if the losses are small the effective size of the slit can be very small. For example, because of the highly reflective nature of the gold coated surface of the surface emitting laser the effective slit size d can be less than about 20 microns and even as small as about 10 microns. However, the gap at the end of the chamber 22 can be made hundreds of microns wide, even as wide as the chamber height w. In this way all that is required is to generally line the pump laser source up with the wide opening and the optical pump power will be fully received within the chamber 22. In FIG. 3 it will be noted that the electrical contacts 88, 89 are on either side of the laser source. Thus, the two halves of the body 96, 98 can be used as an electrical contact and need not be electrically isolated from one another.

In the first embodiment of the present invention as shown in FIGS. 1 and 2, an edge emitting laser source is used, which requires the formation of an actual small slit 34 in the chamber wall with precise alignment of the pump source to the slit. While still permitting sufficient energy to be coupled to the chamber, there are several additional design constraints for this embodiment. For example it is necessary to configure the mode propagation of the edge emitting laser having regard to the size of slit d that the energy is passing through. Thus, if the beam spread from the optical energy source is large, then the slit needs to be large also or the energy will not be coupled to the chamber and will be lost. Further this embodiment is more difficult to fabricate, as the alignment of the energy source to the slit requires greater manufacturing precision. Additionally, if the laser source 12 is touching the body 14, it is necessary to insulate the body to prevent a short circuit if the body is conductive.

The containment chamber 22 of the present invention has the property that as the absorption by the walls or the signal paths becomes greater, the maximum steady state pump energy intensity in the cavity drops. The drop of pump energy intensity results in a drop in the gain per unit length of guided signal path through the multiport amplifier 10. Thus, according to the present invention an optimal solution is sought, where the doping concentration is chosen to be appropriate for the energy intensity achievable in the chamber 22. The energy intensity is a function of the such factors as the pump intensity, the chamber wall reflectivity, the chamber geometry and the number of absorbing signal paths. All these factors are taken into consideration, with the objective being a high level of inversion of the dopant. Essentially, if the dopant is too low, pump energy is wasted while if the doping is too high, good inversion cannot be achieved and there is little amplification.

As can now be appreciated the present invention can be used to amplify optical signals passing along the guided signal paths. When the pump source is activated, the pump energy is coupled to the chamber, where it is contained and over time, the chamber will achieve a steady state of power intensity. At the steady state conditions, the rate of loss of energy through reflection losses, through slit 34 and through absorption into the doped signal paths equals the optical power insertion rate.

The use of highly reflective surfaces will limit the losses of optical energy, but as noted above, there will still be losses. These losses will manifest themselves as heat energy, which will be released into for example the body 14. Thus, the present invention further comprehends utilizing certain heat management strategies to deal with the waste heat. Of course the optimal heat management means is to tune the parameters of the invention (i.e. reflectivity of the walls, width and slot size, power of optical energy source and dopant concentration) to make the energy transfer to the guided signal paths as efficient as possible. However, the present invention also comprehends that the body 14 be made out of a heat conductive material, such as metal for example. In this way, the body 14 can act as a heat transmitting device to draw waste heat out of the chamber 22. The body can further include active cooling means, such as a fan, water cooling, thermoelectric coolers or the like to deal with such waste heat.

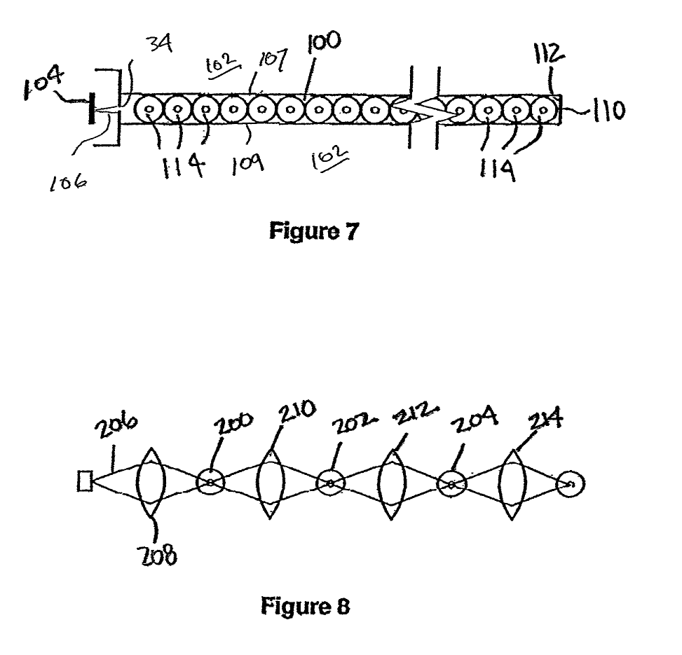

A further embodiment of the present invention is depicted in FIG. 7. In this version the body 100 is made from a solid transparent material, such as glass, having a first index of refraction. The body 100 is surrounded by a material 102, such as air, having a second index of refraction, which is less than the first index of refraction. The ratio of the indexes of refraction of the body 100 to the surrounding media 102 is such that a critical angle for total internal reflection (TIR) occurs. Then the optical pump source 104 is oriented so that the pump energy 106 impinges on the top wall 107 and the bottom wall 109 at an angle less than the critical angle. In such a case, all of the energy input into the body 100 at less than the critical angle will be contained, by TIR, and thus directed reflected, towards the end 110, opposite the optical power source 104. This end 110 is made reflective, for example by a gold or other reflective coating 112. Such a configuration results in a high containment coefficient for the body, allowing an energy intensity to build up which is sufficient to amplify optical signals over a reasonably short amplification path length. There will be losses however, through the slit 34 and as a result of refraction of the pump beam as it passes through the cladding and the core. A fraction of the beam will be diverted to an angle above the critical angle meaning that loss of power will occur through the surface of the body. However, these types of losses are expected to be small as compared to the energy absorbed in the dopant. Further, the present invention comprehends a further reflective surface, outside the body, to reflect this energy back into the body. While this embodiment has certain advantages, there are disadvantages as well, such as it may be more difficult to remove the waste heat which is generated since glass is an insulating rather than a conductive material. Also shown are a plurality of signal paths 114.

An example of a construction according to the present invention, includes a cavity which is 5 cm long, 3 mm deep, and 100 to 200 μm high, with up to 16 fibres. Preferred pump power for this chamber ranges between 75 to 100 W total. Achievable power intensity in the chamber depends on the version of the invention being used. It is believed that the preferred configuration is a TIR cavity with gold-coated back and front faces, and a 10 μm or smaller effective d for entrance slit 34. In this case intensities around 6 kW/cm² for 8 fibres, or 4 kW/cm² for 16 fibres are expected. For the embodiment having a fully optimised metallic reflector, 3 and 2 kW/cm², respectively are expected. Based on the foregoing, gains would be up to 20 dB for a 5 cm, 8 fibre, TIR cavity, and perhaps 10 dB for a 5 cm metallic, lower-doped 16 fibre design.

In a further embodiment of the present invention, the pump energy from a single pump source is again used to amplify a plurality of optical signal paths. In FIG. 8, these are shown as 200, 202, 204 and the like. In this form of the invention, the pump energy 206 is first focussed through a lens 208 onto a first guided signal path 200. Some of the energy will be absorbed, but much of it will simply pass through the doped signal guide 200. The next element in the optical pump beam path is a capturing and refocusing structure 210, then through a lense 212 and then again through a lense 214, each time passing through a subsequent signal path; This can be repeated for a number of parallel signal paths meaning that the pump energy is reused, or at least used to pump a plurality of signals. In this sense, the amplifier body is considered to be the various recapture and refocusing sections between adjacent signal paths. An advantage of this embodiment is that the energy of the pump source can be focussed and thus concentrated to very high energy densities on the energy absorbing portion of the guided signal path. Higher energy density permits more dopant to be used meaning that the amount of energy transferred into the signal is also high. This embodiment therefore can achieve high gain per unit length of pumped signal path. On the downside however, this embodiment requires very precise alignment of each of the elements along the optical pump signal beam path and thus is more expensive and more difficult to make than the other preferred embodiments discussed herein.

It will be appreciated by those skilled in the art that various modifications can be made to the invention without departing from the scope of the broad claims attached. Some of these variations have been discussed above and others will be apparent to those skilled in the art. For example, the energy of the pump beam may be contained by total internal reflection, or by reflection off a reflecting surface or by recapture and refocusing. Essentially what is required is to provide enough energy density in the amplification chamber to permit the signals passing therethrough to be amplified in a meaningful way by side pumping energy. The amplification factor is of course a function of the doping of the signal paths as well as the energy intensity within the amplification chamber. Common to all aspects of the invention is the amplification of more than one guided signal path by a single pump source.

The embodiments of the invention in which an exclusive property or privilege is claimed are defined as follows:

1. An amplifier for optical signals, said amplifier comprising:
a source of optical pump power;
a containment body for substantially containing said pump power at a predetermined power intensity;
at least one guided signal path passing through said containment body, said signal path being capable of carrying at least one optical signal component; and
a means for coupling said source of power to said containment body.

2. An amplifier for optical signals as claimed in claim 1 wherein said guided signal path comprises a cladding and a core, and wherein at least said core is doped with a first dopant to permit the core to absorb sufficient of said optical pump power at said predetermined power intensity to amplify said at least one optical signal carried by said signal path.

3. An amplifier for optical signals as claimed in claim 2 wherein at said cladding is doped with a second dopant to permit said cladding to absorb said pump energy and said core is doped with said first dopant to permit said core to obtain energy from said cladding to amplify said signal.

4. An amplifier for optical signals as claimed in claim 2 wherein said cladding is substantially transparent to said pump power.

5. An amplifier for optical signals as claimed in claim 1 wherein said amplifier is a multiport amplifier and said containment body is sized and shaped to carry a plurality of guided signal paths, each of said guided signal paths capable of carrying at least one signal component.

6. An amplifier for optical signals as claimed in claim 1 wherein said containment body includes a reflecting surface to contain said pump power enough to achieve said predetermined power intensity

7. An amplifier for optical signals as claimed in claim 1 wherein said containment body includes a heat management means to manage heat produced in said containment body.

8. An amplifier for optical signals as claimed in claim 7 wherein said heat management means comprises forming said containment body out of a heat conductive material.

9. An amplifier for optical signals as claimed in claim 8 wherein said heat conductive material is metal.

10. An amplifier for optical signals as claimed in claim 7 wherein said heat management means further includes a cooling means.

11. An amplifier for optical signals as claimed in claim 10 wherein said cooling means comprises a heat sink.

12. An amplifier for optical signals as claimed in claim 7 wherein said cooling means comprises a blower.

13. An amplifier for optical signals as claimed in claim 1 wherein said containment body is made from a transparent medium and said pump power is contained in said transparent medium by internal reflection.

14. An amplifier for optical signals as claimed in claim 13 wherein said transparent medium is glass.

15. An amplifier for optical signals as claimed in claim 1 wherein said means for coupling said pump power to said containment body comprises a light transmissive portion on said containment body sized and shaped to permit said pump power to enter said containment body.

16. An amplifier for optical signals as claimed in claim 15 wherein said source of optical pump power is a surface emitting power source, wherein said surface is substantially reflective to optical power.

17. An amplifier for optical signals as claimed in claim 16 wherein said means for coupling said source of pump power to said containment body further comprises positioning said substantially reflective surface of said surface emitting power source across said light transmissive portion to help define said containment body.

18. An amplifier for optical signals as claimed in claim 17 wherein said surface emitting power source is directed transversely to said at least one guided signal path.

19. An amplifier for amplifying optical signals, said amplifier comprising:
a reflective containment body;
a source of pump light directed into said containment body;
at least one doped guided signal path passing through said containment body, and
a means for coupling said source of pump light to said containment body, wherein said pump light is directed generally transverse to said at least one guided signal path and is reflected back through said signal paths by said reflective surface.

20. An amplifier for optical signals as claimed in claim 19 wherein said guided signal path comprises a cladding and a core, and wherein at least said core is doped with a first dopant to permit the core to absorb sufficient of said optical pump power at said predetermined power intensity to amplify said at least one optical signal carried by said signal path.

21. An amplifier for optical signals as claimed in claim 20 wherein at said cladding is doped with a second dopant to permit said cladding to absorb said pump energy and said core is doped with said first dopant to permit said core to obtain energy from said cladding to amplify said signal.

22. An amplifier for optical signals as claimed in claim 20 wherein said cladding is substantially transparent to said pump power.

23. An amplifier for optical signals as claimed in claim 19 wherein said amplifier is a multiport amplifier and said containment body is sized and shaped to carry a plurality of guided signal paths, each of said guided signal paths capable of carrying at least one signal component

24. An amplifier for optical signals as claimed in claim 19 wherein said containment body includes a reflecting surface to contain enough of said pump power to achieve said predetermined power intensity.

25. An amplifier for optical signals as claimed in claim 19 wherein said containment body includes a heat management means to manage heat produced in said containment body.

26. An amplifier for optical signals as claimed in claim 25 wherein said heat management means comprises forming said containment body out of a heat conductive material.

27. An amplifier for optical signals as claimed in claim 26 wherein said heat conductive material is metal.

28. An amplifier for optical signals as claimed in claim 26 wherein said heat management means further includes a cooling means.

29. An amplifier for optical signals as claimed in claim 28 wherein said cooling means comprises a heat sink.

30. An amplifier for optical signals as claimed in claim 28 wherein said cooling means comprises a blower.

31. An amplifier for optical signals as claimed in claim 19 wherein said containment body is made from a transparent medium and said pump power is contained in said transparent medium by internal reflection.

32. An amplifier for optical signals as claimed in claim 26 wherein said transparent medium is glass.

33. An amplifier for optical signals as claimed in claim 19 wherein said means for coupling said pump power to said containment body comprises a light transmissive portion on said containment body sized and shaped to permit said pump power to enter said containment body.

34. An amplifier for optical signals as claimed in claim 19 wherein said source of optical pump power is a surface emitting power source, wherein said surface is substantially reflective to optical power.

35. An amplifier for optical signals as claimed in claim 29 wherein said means for coupling said source of pump power to said containment body further comprises positioning said substantially reflective surface of said surface emitting power source across said light transmissive portion to help define said containment body.

36. An amplifier for amplifying optical signals said amplifier comprising:
a reflective containment body filled with pump energy; and
at least one doped guided signal path in said containment body, said doped guided signal path responding to said pump energy by having a population inversion sufficient to amplify an optical signal passing along said guided signal path;
wherein said pump energy is applied substantially transversely to said guided signal paths.

37. An amplifier for amplifying optical signals as claimed in claim 26 wherein said guided signal path has a length, and said pump energy is applied along said length.

38. A method of amplifying an optical signal comprising the steps of:
providing a containment body to contain an optical pump energy, said containment body having at least one guided signal path passing therethrough;
pumping said containment body with enough optical pump energy to permit said containment body to achieve a predetermined energy intensity level;
stimulating a guided signal path with said energy intensity; and
amplifying an optical signal passing through said guided signal path.

39. A method of amplifying an optical signal as claimed in claim 28 wherein said containment body includes a plurality of guided signal paths and said step of stimulating said at least one guided signal path includes simultaneously stimulating all of said signal paths passing through said containment body.

40. An amplifier for amplifying optical signals, said amplifier comprising:
an amplifier body;
at least two doped guided signal paths passing through said body;
at least one source of pump energy directed at said body;
wherein said pump energy impinges on both of said at least two doped guided signal paths.
